(19) United States
(12) Patent Application Publication
(10) Pub. No.: US 2020/0387883 A1
(43) Pub. Date: Dec. 10, 2020

(54) PAYMENT TYPE RECOMMENDATION SYSTEM AND PAYMENT TYPE RECOMMENDATION METHOD

(71) Applicant: Quanta Computer Inc., Taoyuan City (TW)

(72) Inventors: Wen-Kuang CHEN, Taoyuan City (TW); Chien-Kuo HUNG, Taoyuan City (TW); Chun-Hung CHEN, Taoyuan City (TW); Chen-Chung LEE, Taoyuan City (TW)

(21) Appl. No.: 16/661,355

(22) Filed: Oct. 23, 2019

(30) Foreign Application Priority Data
Jun. 4, 2019 (TW) 108119252

(51) Int. Cl. G06Q 20/22; G06Q 30/02; G06Q 20/24

(52) U.S. Cl. CPC G06Q 20/227; G06Q 20/24; G06Q 30/0233

(57) ABSTRACT

The payment type recommendation method includes the following steps: obtaining payment data; generating a store group and a company group according to payment type and consumption location in the payment data; calculating the store payment average ratio according to the payment type corresponding to the store group; calculating the company average payment ratio according to the payment type corresponding to the company group; generating the user payment preference according to the company average payment ratio; defining the preference order according to the amount of the user payment preference; calculating the overall return rate according to the preference order using the wholesale price, the expected revenue weight, the user payment preference, a payment combination, and a total cost; and displaying the payment combination and the overall return rate corresponding to the payment combination on a display screen.

### CROSS REFERENCE TO RELATED APPLICATIONS

This Application claims priority of Taiwan Patent Application No. 108119252, filed on Jun. 4, 2019, the entirety of which is incorporated by reference herein.

### BACKGROUND OF THE INVENTION

### Field of the Invention

The present disclosure relates to a recommendation system and, in particular, to a payment type recommendation system and a payment type recommendation method.

### Description of the Related Art

In the field of mobile payment, several types of payment are available. These include free points given by the company, points of cash deposited on the mobile payment device, pay by credit card, points earned by the campus market, points earned from the consumption feedback, etc. With so many payment options, the payer may often be unclear about which type of credit card or points system can earn him the most benefits or the lowest cost in any particular payment. It is difficult for a consumer to decide which type to use at which time to achieve the most benefits and lowest cost.

Therefore, how to recommend the user to use the most appropriate payment combination according to the expected rate of return has become one of the problems to be solved in the field.

### BRIEF SUMMARY OF THE INVENTION

In accordance with one feature of the present invention, the present disclosure provides a payment type recommendation system that comprises a data storage device and a processor. The processor obtains the payment data, generates a store group and a company group according to the payment type and a consumption location in the payment data, calculates the store payment average ratio according to the payment type corresponding to the store group, calculates the company average payment ratio according to the payment type corresponding to the company group, generates the user payment preference according to the company average payment ratio, defines the preference order according to the amount of the user payment preference, calculates the overall return rate according to the preference order using the wholesale price, the expected revenue weight, the user payment preference, a payment combination, and a total cost, and display the payment combination and the overall return rate corresponding to the payment combination on a display screen.

In accordance with one feature of the present invention, the present disclosure provides a payment type recommendation method. The payment type recommendation method comprises the following steps: obtaining payment data; generating a store group and a company group according to payment type and consumption location in the payment data; calculating the store payment average ratio according to the payment type corresponding to the store group; calculating the company average payment ratio according to the payment type corresponding to the company group; generating the user payment preference according to the company average payment ratio; defining the preference order according to the amount of the user payment preference; calculating the overall return rate according to the preference order using the wholesale price, the expected revenue weight, the user payment preference, a payment combination, and a total cost; and displaying the payment combination and the overall return rate corresponding to the payment combination on a display screen.

By learning and adjusting the mechanism along with the user's consumption habits and time changes, the expectation recommendation mechanism can satisfy the consumer's expected expectation rules and seek the maximum expected revenue rate. This mechanism combines dynamic learning methods to calculate reasonable user payment preference values at different time points, and uses algorithms to dynamically plan and calculate various types of payment combinations. Finally, the mechanism calculates the expected revenue rate for each payment combination, and recommends the user to use the most appropriate payment combination according to the expected revenue rate.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only example aspects of the disclosure and are not therefore to be considered to be limiting of its scope, the principles herein are described and explained with additional specificity and detail through the use of the accompanying drawings in which:

FIG. 1 is a payment type recommendation system in accordance with one embodiment of the present disclosure.

FIG. 2 is a payment type recommendation system in accordance with one embodiment of the present disclosure.

FIG. 3 is a payment type recommendation method in accordance with one embodiment of the present disclosure.

FIG. 4 is a schematic diagram of the summary method of payment data in accordance with one embodiment of the present disclosure.

FIG. 5 is a schematic diagram of generating the store group and the company group in accordance with one embodiment of the present disclosure.

FIG. 6 is a schematic diagram of a method of determining payment combinations by using dichotomy in accordance with one embodiment of the present disclosure.

FIG. 7 is a flowchart of a method of determining payment combinations by using dichotomy in accordance with one embodiment of the present disclosure.

FIG. 8 is a flowchart of revising method for revising the user payment preferences in accordance with one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

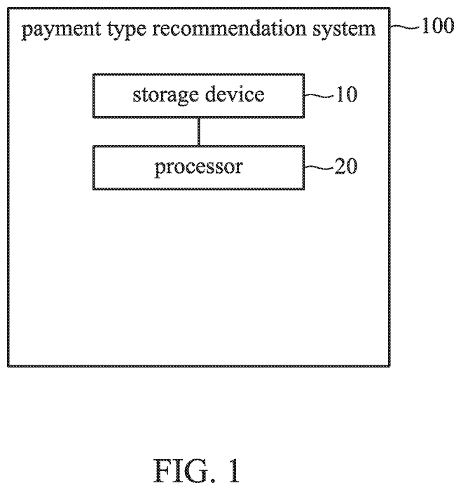

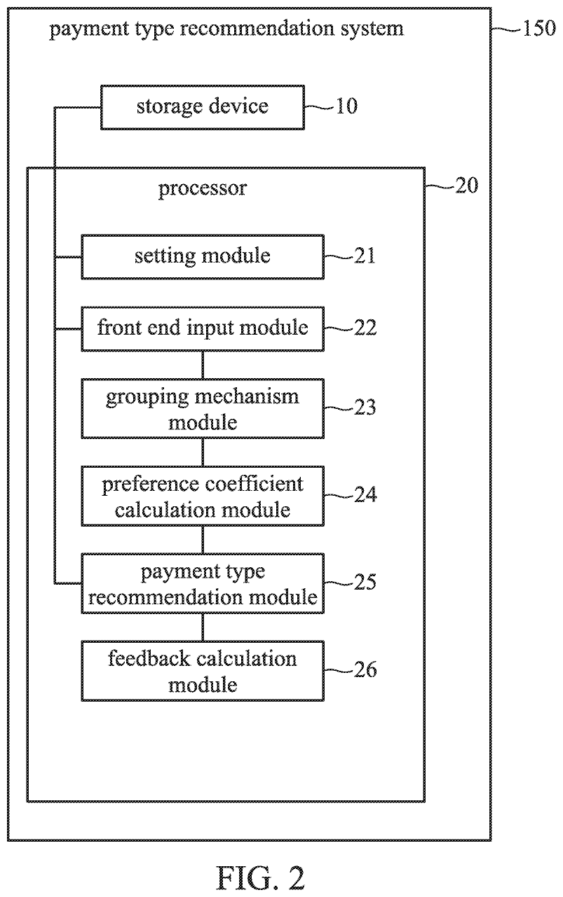

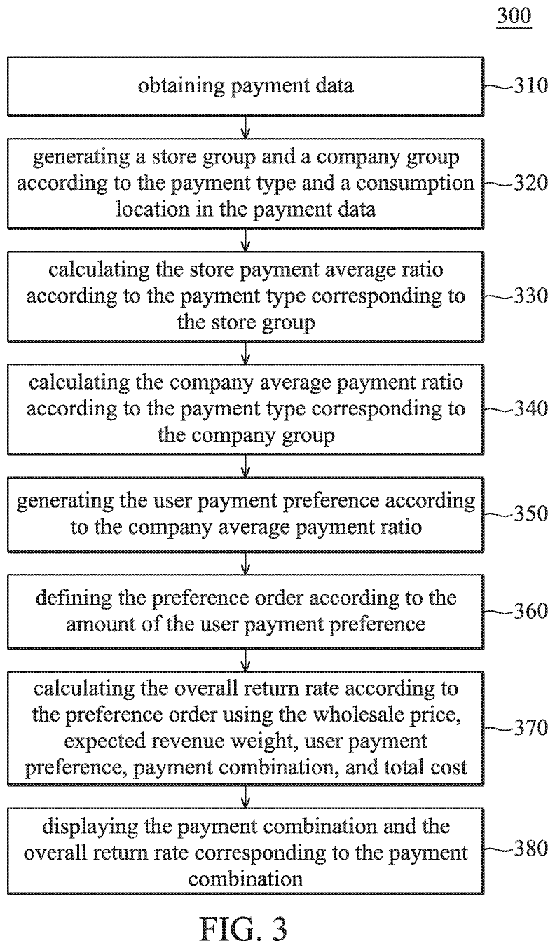

FIGS. 1-2 and 3, FIG. 1 is a payment type recommendation system 100 in accordance with one embodiment of the present disclosure. FIG. 2 is a payment type recommendation system 150 in accordance with one embodiment of the present disclosure. FIG. 3 is a payment type recommendation method 300 in accordance with one embodiment of the present disclosure.

As shown in FIG. 1, the payment type recommendation system 100 is suitable for an electronic device. The electronic device is, for example, a mobile phone, a tablet, a notebook or other device having calculation function. The payment type recommendation system 100 includes a storage device 10 and a processor 20. In one embodiment, the payment type recommendation system 100 is further included a global positioning system (GPS) for determining the position. In one embodiment, the storage device 30 can be implemented as a read-only memory, a flash memory, a floppy disk, a hard disk, a compact disk, a flash drive, a tape, a network accessible database, or as a storage medium that can be easily considered by those skilled in the art to have the same function. In one embodiment, the processor 20 can be implemented by using an integrated circuit, such as a microcontroller, a microprocessor, a digital signal processor, an application specific integrated circuit (ASIC), or a logic circuit. However, it is not limited thereto.

As shown in FIG. 2, the payment type recommendation system 150 includes a storage device 10 and a processor 20. The processor includes a setting module 21, a front end input module 22, a grouping mechanism module 23, a preference coefficient calculation module 24, a payment type recommendation module 25, and a feedback calculation module 26. These modules may be implemented together or separately by a integrated circuit such as a micro control unit, a microprocessor, a digital signal processor, a special application integrated circuit or a logic circuit.

The payment type recommendation method 300 is described below, and the payment type recommendation method 300 can be implemented by the payment type recommendation system 100 or 150.

In one embodiment, in the setup step, the setting module 21 is responsible for providing an interface for the administrator to set relevant rules. The settable rules include grouping rule settings, expected revenue weight settings, and expected rate of return settings.

In one embodiment, the grouping rule setting means that the administrator can set the grouping rules of different company employees, consumption amount interval and statistical time interval. For example, company A will concentrate on consumption in some places. The consumption habits in the morning, noon and evening meals may be different. Consumption habits at different time points may change with time. In general, similar groups of people will have similar payment habits, such as the type of points (e.g., pay points) that provided by the company A. Most employees of company A have this type of points, and these employees may be preferentially paid by the company's points.

In one embodiment, the expected revenue weight setting means that each payment type has its limits, such as the limit on the usage time of the points, the bonus discount of the payment tool, the number of points gave by the company, or the deposited value of the cash. When calculating the overall rate of return, the expected revenue weight are used to find the sorting combination with the lowest cost and the most profit. An example of the expected revenue weight setting is shown in Table 1 below:

TABLE 1

| | |
|---|---|
| payment | expected revenue weight |
| type | |
| annual | 100% free to obtain, each point saves one dollar, so |
| points | the expected revenue weight is 100%. |
| deposited | 0% discount, if the store sets a preference for depos- |
| cash | ited cash, the administrator can set the payment type |
| | in the group or store to 10%, as long as it is consumed |
| | in the designated store, the consumer can enjoy the 10% |
| | discount. Therefore, environmental factors or consumption |
| | restrictions increase the expected revenue. |
| campus | A campus market point can be obtained 100% free on |
| market | April 1. If it is not on this date, the expected revenue |
| points | weight is 0%. Therefore, if points are about to expire, |
| | priority of the point(s) will be given to consumption. |
| | For example, assuming that there is 800 dollars available |
| | to spend on April 1 of the campus market, and if the |
| | user uses the campus market point to pay 500 dollars, |
| | which means that the user earns 500 dollars. Therefore, |
| | each campus market points has a return of 1 dollar, |
| | and the expected revenue weight is 100%. |
| credit | Dividend feedback is 2%, if the consumption of 500 |
| card | dollars, the dividend is 10 dollars. Therefore, each |
| | point of consumption will have a revenue of 0.02 |
| | dollars, the administrator can set that each credit |
| | card can enjoy the discount in the store. |

As can be seen from Table 1, the payment type and its corresponding expected revenue weight can be defined in advance. It should be understood by the person having ordinary skill in the art to adjust the contents of Table 1 according to the implementation of the system, and only examples are provided herein.

In one embodiment, the storage device 10 stores the expected revenue weight corresponding to the payment type.

In step 310, the front end input module 22 obtains payment data.

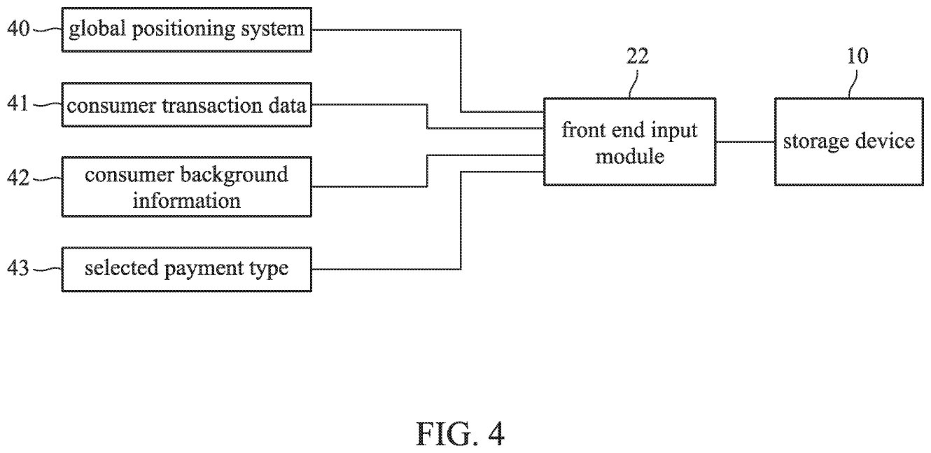

Refer to FIG. 4, FIG. 4 is a schematic diagram of the summary method of payment data in accordance with one embodiment of the present disclosure. In one embodiment, the payment data includes the payment type 43, global positioning system (GPS) data 40, consumer transaction data 41 and consumer background information 42.

The payment type 43 includes an annual point payment type, a deposited cash payment type, a campus market point payment type or a credit card payment type. The global positioning system 40 data comprises the consumption location. The consumer transaction data 41 comprises store type. The consumer background information 42 includes a company, a group name, a gender profile and a place of residence information.

In one embodiment, the front end input module 22 is configured to receive basic information inputted by the user and the behavior of the user operation, and read information related to the global positioning system data 40 and the selected payment type 43 from the electronic device. Also, these data is sent to the grouping mechanism module 23 for grouping. For example, these data may be classified into a consumption amount interval, store type, consumption time, consumer group, and/or transaction amount interval.

In addition, the front end input module 22 also analyzes and processes the consumption records, and integrates the global positioning system data 40, the consumer transaction data 41 and the consumer background data 42, and reads the transaction consumption records to calculate the ratio of the payment type 43 of the individual cases in different situations. Then, the ratio of the payment type 43 is stored in the database in the storage device 10.

In step 320, the grouping mechanism module 23 generates a store group 53 and a company group 57 according to the payment type and a consumption location in the payment data.

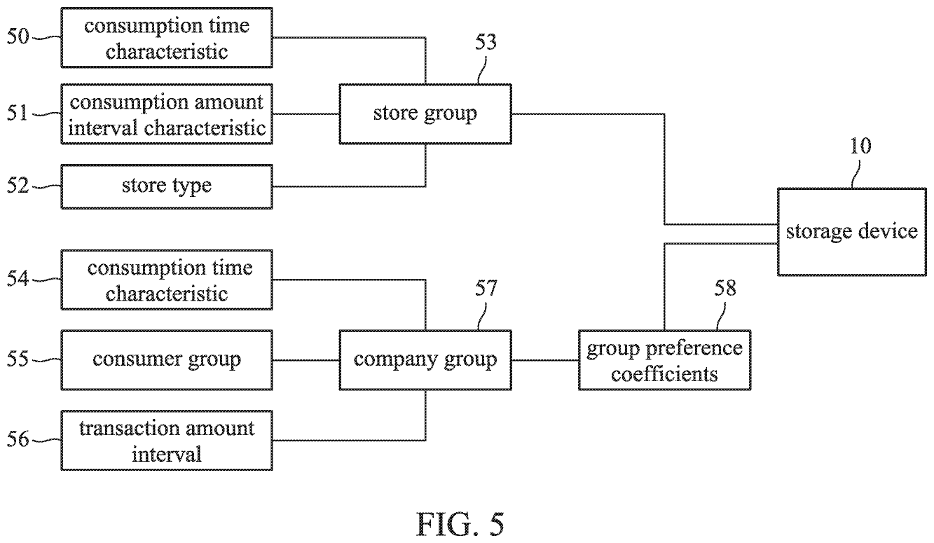

Refer to FIG. 5, FIG. 5 is a schematic diagram of generating the store group and the company group in accordance with one embodiment of the present disclosure. In one embodiment, the grouping mechanism module 23 generates the store group 53 and the company group 57 respectively according to the output group of the front end input module 22, and classifies the store group 53 according to the consumption time characteristic 50, the consumption amount interval characteristic 51, and the store type 52, respectively. The company group 57 is classified according to the consumption time characteristic 54, the consumer group 55, and/or the transaction amount interval 56. Also, the storage device 10 is configured to record the store group 53 and the company group 57. The group preference coefficients 58 can be generated according to the data of company group 57.

In one embodiment, the grouping mechanism module 23 collects the daily payment data, performs group calculation according to the time, the consumption location and the consumption amount interval, and captures the grouping rules from the database, and classifies the users into groups. After dividing the groups, the correlation between the payment type and the group to which it belongs is calculated. The group classification will be distinguished by the store and the transaction amount interval, consumption time, and characteristics of the consumer group. According to the setting of the setting module 21 and different payment types are used for payment, the transaction amount interval can be basically divided into large, medium and small amounts. The consumer group will refer to the consumer's background based on the company (such as company group 57) or the location of the global positioning system data. The consumption time characteristics will be differentiated according to the weekend and weekdays, weeks, months, and seasons. The store type 52 will determine the type of store by the contents of the store transaction.

In step 330, the preference coefficient calculation module 24 calculates the store payment average ratio according to the payment type corresponding to the store group 53. For example, the payment type corresponding to the store group 53 is as shown in Table 2 below.

TABLE 2

| payment type | store | 1^{st} day | 7^{th} day | 15^{th} day | 30^{th} day |
|---|---|---|---|---|---|
| annual points | store A | 0.3 | 0.1 | 0.2 | 0.2 |
| deposited cash | store A | 0.2 | 0.4 | 0.35 | 0.33 |
| campus market | store A | 0.9 | 0 | 0 | 0 |
| points | | | | | |
| credit card | store A | 0.4 | 0.6 | 0.5 | 0.45 |

In the example of Table 2, the store A belongs to the store group 53, and for the convenience to explain, the store A is used as the representative of the store group 53. The parameters in Table 2 represent the user payment preferences of the store A.

In one embodiment, the user payment preference of the store A may represent a ratio of one of the payment types corresponding to the store group 53 at a plurality of time point. In one embodiment, the user payment preference of the store A refers to the payment type preferred by the store A. Also, the payment type preferred by store consumers on weekdays and holidays is not sure for the best type of payment at the moment. The user payment preferences of store A may be affected by the likes of the same group and tend to be similar to the payment type used by the group. For example, in the 1, 7, 15, and 30 day time preference ratio of each store, 30% (i.e., 0.3) of the payment within the last day is the annual point payment. Based on the data, after the user payment preference of the store A is generated, the store payment average ratio is calculated. That is, the store payment average ratio is calculated according to Table 2. Also, the calculation formula is as follows:

$${AGR}_{p t} = \frac{{\sum }_{t = 1}^{n} {R}_{p t}}{n}$$

The symbol t represents the time interval, such as 1, 7, 15, 30, etc., the time calculation will be divided into holidays and weekdays. The symbol p represents the payment type, such as annual points, deposited cash, campus market points, and credit card. The symbol n represents the total use number of the current record, such as the consumption time points of the above four time points. The symbol Rₚₜ represents the proportion of payments made using this payment type at each time point. The symbol AGRₚₜ is the average of each payment type used in store A (i.e., the store payment average ratio). Based on the above, the calculation results are as shown in Table 4.

TABLE 4

| | the average of each |
|---|---|
| payment type | payment type used in store A (AGRₚₜ) |
| annual points | $\frac{0.3 + 0.1 + 0.2 + 0.2}{4} = 0.2$ |
| deposited cash | $\frac{0.2 + 0.4 + 0.35 + 0.33}{4} = 0.32$ |
| campus market points | $\frac{0.9 + 0 + 0 + 0}{4} = 0.225$ |
| credit card | $\frac{0.4 + 0.6 + 0.45 + 0.5}{4} = 0.48$ |

It can be seen that the preference coefficient calculation module 24 sums the proportions of the payment types corresponding to the respective groups of the plurality of time points of the store group 53 to obtain an operation result. Then, the preference coefficient calculation module 24 divides the operation result by the number of time points (4 in this example) to obtain the store payment average ratio.

In step 340, the preference coefficient calculation module 24 calculates the company average payment ratio according to the payment type corresponding to the company group 57. The company A shown in Table 3 below belongs to company group 57. For the convenience of explanation, company A is representative of company group 57. The parameters in Table 5 represent the user payment preference of company A.

TABLE 5

| payment type | group | 1^{st} day | 7^{th} day | 15^{th} day | 30^{th} day |
|---|---|---|---|---|---|
| annual points | company A | 0.1 | 0.1 | 0.2 | 0.2 |
| deposited cash | company A | 0.4 | 0.8 | 0.7 | 0.6 |
| campus market | company A | 0.8 | 0.5 | 0.2 | 0.1 |
| points | | | | | |
| credit card | company A | 0 | 0 | 0 | 0 |

In one embodiment, the user payment preference of company A may represent a ratio of one of the payment types of the company group 57 at each of the multiple time points. In one embodiment, the user payment preference of company A refers to the preferred payment type of company A. The payment type preferred by the consumer A′ of company A on weekdays and holidays is not sure to be the best payment type at the moment, and user payment preferences of company A may be affected by the likes of the same group and tended to be similar to the payment type used by the group. For example, in the time preference ratio of 1^{st}, 7^{th}, 15^{th}, and 30^{th} day of company A, 10% (or 0.1) of the payment within the last day is the annual points. Based on these data, after the user payment preferences of company A is generated, the company average payment ratio will be calculated, that is, the company average payment ratio calculated according to Table 5, the formula is as follows:

$${PAR}_{p t} = \frac{{\sum }_{t = 1}^{n} {R}_{p t}}{n}$$

The symbol t represents the time interval, such as 1, 7, 15, 30, etc., the time calculation will be divided into holidays and weekdays. The symbol p represents the payment type, such as annual points, deposited cash, campus market points, and credit card. The symbol n represents the total use number of the current record, such as the consumption time points of the above four time points. The symbol Rₚₜ represents the proportion of payments made using this payment type at each time point. The symbol PARₚₜ represents the average consumption ratio of the group's payment type (i.e., the company average payment ratio). For the convenience of explanation, the consumer A′ is used for representing the affiliated company A. Based on the above, the calculation results are as shown in the following Table 6.

TABLE 6

| | the average ratio of the specific |
|---|---|
| | payment types used by consumer A′ |
| payment type | of company A at each time point (PARₚₜ) |
| annual points | $\frac{0.1 + 0.1 + 0.2 + 0.2}{4} = 0.15$ |
| annual points | $\frac{0.4 + 0.8 + 0.7 + 0.6}{4} = 0.625$ |
| campus market points | $\frac{0.6 + 0.5 + 0.2 + 0.1}{4} = 0.35$ |
| credit card | $\frac{0 + 0 + 0 + 0}{4} = 0$ |

Therefore, the preference coefficient calculation module 24 aggregates the proportions of the payment types corresponding to the company group 57 at a plurality of time points to obtain the operation result. Then, the preference coefficient calculation module 24 divides the operation result by the number of time points (4 in this example) to obtain the company average payment ratio.

In step 350, the preference coefficient calculation module 24 generates the user payment preference according to the company average payment ratio. In one embodiment, the preference coefficient calculation module 24 generates the user payment preferences according to the following formula.

$${PR}_{p} = ( \begin{matrix}( {PAR}_{p t} + {AGR}_{p t} ) / 2 \\ {AGR}_{p t}\end{matrix} )$$

The symbol t represents the time interval, such as 1, 7, 15, 30, etc., the time calculation will be divided into holidays and weekdays. The symbol PARₚₜ represents the average consumption ratio of individuals spending on this payment type. The symbol AGRₚₜ is the average of each payment type used in store A (i.e., the store payment average ratio). The symbol p represents the payment type, such as annual points, deposited cash, campus market points, and credit card. The symbol PR_{P} represents the user payment preferences of the payment type in the group.

In step 360, after the preference coefficient calculation module 24 generates the user payment preference according to the company average payment ratio, the preference coefficient calculation module 24 define the preference order according to the amount of the user payment preference. As shown in Table 7, the preference coefficient calculation module 24 sorts the user payment preferences (i.e., user payment preferences of consumer A′) calculated in step 350 by their amount. The preference coefficient calculation module 24 sets the maximum to 1, the second largest to 2, and so on.

TABLE 7

| | the user payment | preference |
|---|---|---|
| payment type | preferences of consumer A′ (PR_{P}) | order |
| annual points | $\frac{( 0.2 + 0.15 ) / 2}{0.2} = 0.875$ | 3 |
| deposited cash | $\frac{( 0.32 + 0.625 ) / 2}{0.32} = 1.47$ | 1 |
| campus market points | $\frac{( 0.225 + 0.35 ) / 2}{0.225} = 1.27$ | 2 |
| credit card | $\frac{( 0.48 + 0 ) / 2}{0.48} = 0.5$ | 4 |

In some embodiments, in different store groups 53, the annual points even will correspond to different user payment preferences, as shown in Table 8 below.

TABLE 8

| | consumer A | | consumer C |
|---|---|---|---|
| | e.g., food | consumer B | e.g., coffee |
| | court | e.g., gym | shop |
| 1^{st} day | 0.8 | 0.3 | 0.2 |
| 7^{th} day | 0.77 | 0.55 | 0.44 |
| holiday | 0.3 | 0.7 | 0 |
| 30^{th} day | 0.66 | 0.45 | 0.3 |

As can be seen from the above, the preference coefficient calculation module 24 adds the store payment average ratio to the company average payment ratio, and then divides it by two to obtain an operation result. The preference coefficient calculation module 24 divides the operation result by the store payment average ratio to obtain the user payment preference. Thereby, the payment type of the particular user's preference in different stores can be known.

In step 370, the payment type recommendation module 25 calculates the overall return rate according to the preference order using the wholesale price, expected revenue weight, user payment preference, payment combination, and total cost.

In step 380, a display screen is configured to display the payment combination and the overall return rate corresponding to the payment combination.

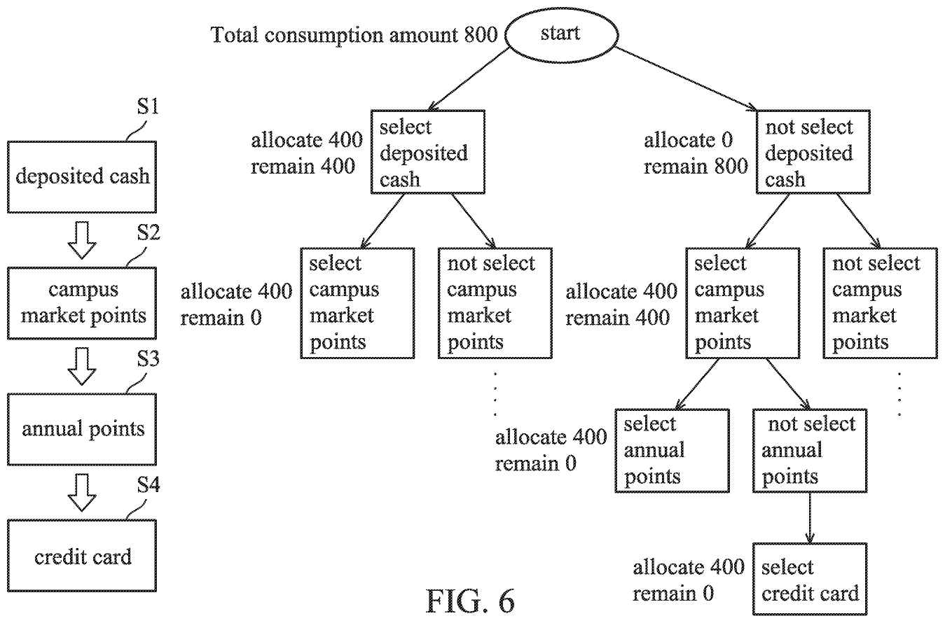

Refer to FIG. 6, FIG. 6 is a schematic diagram of a method of determining payment combinations by using dichotomy in accordance with one embodiment of the present disclosure. In the example of FIG. 6, assuming that the first preference order S1 corresponds to the payment type of deposited cash, the second preference order S2 corresponds to the payment type of campus market points, the third preference order S3 corresponds to the payment type of annual points, the fourth preference order S4 corresponds to the payment type of credit card, the payment type recommendation module 25 will use the dynamics of the dichotomy to determine the next assigned payment type according to the user payment preference. The method starts from selecting the payment type of the first order (i.e., the first preference order S1) and the second order (i.e., the second preference order S2). Also, the following function is used to calculate the total cost of the user for each payment type.

FRᵢ=(ROI_{P}×FRₚ×Cₚᵢ)

The symbol Cₚᵢ is the amount the individual pays using this payment type. The symbol PRₚ is the user payment preference for the current payment type. The symbol ROIₚ is the user's expected weight for the current payment type. The condition for stopping the search of this function is as follows.

$${\sum }_{i = 1}^{n} {C}_{p i} \leq {TC}_{ a} , \frac{{\sum }_{i = 1}^{n} FRi}{{TC}_{a}} \geq {ROI}_{a}$$

The symbol i is the number of payment types assigned. The symbol TCₐ is the total cost of this consumption. If it is greater than the total cost, the dichotomy will not continue to expand. The symbol Cₚᵢ is the amount the user pays for the current payment type. The symbol FRᵢ is the total cost of the user for the current payment combination. The symbol ROIₐ is the expected revenue weight.

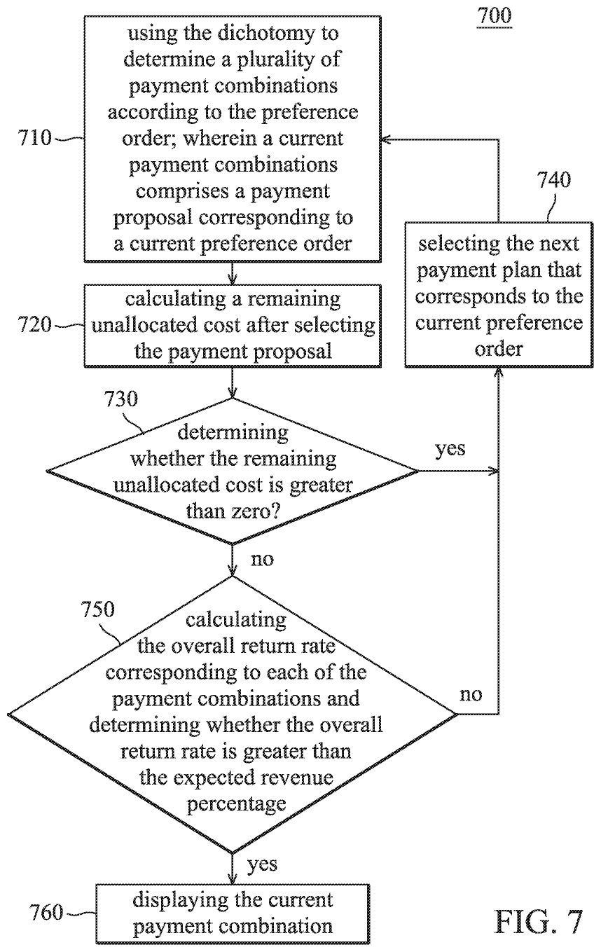

Refer to FIG. 6 and FIG. 7, FIG. 7 is a flowchart of a method 700 of determining payment combinations by using dichotomy in accordance with one embodiment of the present disclosure.

In step 710, the payment type recommendation module 25 uses the dichotomy to determine a plurality of payment combinations (e.g., credit card payment type and credit card payment type) according to the preference order. Also, current payment combinations comprise a payment proposal (e.g., deposited cash) corresponding to a current preference order (e.g., user payment preferences as 1).

In step 720, the payment type recommendation module 25 calculates the remaining unallocated cost after selecting the payment proposal. For example, the total cost of consumption at the beginning is 800 dollars, and after the user allocates 400 dollars to the deposited cash payment type, the remaining 400 dollars is left (that is, the remaining unallocated cost).

In step 730, the payment type recommendation module 25 determines whether the remaining unallocated cost is greater than zero. If the payment type recommendation module 25 determines that the remaining unallocated cost is greater than zero, which means the remaining unallocated cost is left, and the step 740 is performed. If the payment type recommendation module 25 determines that the remaining unallocated cost is not greater than zero, which means the total cost of consumption in this time is has been configured, and the step 750 is performed.

In step 740, the payment type recommendation module 25 selects the next (e.g., the secondary) payment plan that corresponds to the current preference order (for example, campus market point payment type).

In step 750, the payment type recommendation module 25 calculates the overall return rate corresponding to each of the payment combinations and determines whether the overall return rate is greater than the expected revenue percentage. If the payment type recommendation module 25 determines that the overall return rate is greater than the expected revenue percentage, the step 760 is performed. If the payment type recommendation module 25 determines that the overall return rate is not greater than the expected revenue percentage, the step 740 is performed.

In step 760, the current payment combination is displayed.

For example, at the beginning, the user allocates 400 dollars to deposited cash, and then allocates the remaining 400 dollars to campus market points. In this example, the current payment combination includes deposited cash and campus market points, and the total cost is 400*10%*1.47+400*100%*1.27=566.8. The overall return rate is 566.8/800=70.5% (this example can be calculated according to the contents of the above functions, Table 1 and Table 7).

In another example, at the beginning, the user does not allocate dollars to deposited cash. The user allocates the 400 dollars to campus market points and allocates the remaining 400 dollars to annual point. In this example, the current payment combination includes the campus market points and the annual point, and the total cost is 400*100%*1.27+400*100%*0.875=858. The overall return rate is 858/800=107.25% (this example can be calculated according to the contents of the above functions, Table 1 and Table 7).

In another example, at the beginning, the user does not allocate dollars to deposited cash. The user allocates the remaining 400 dollars to credit card. In this example, the current payment combination includes the deposited cash and the credit card, and the total cost is 400*10%*0.875+400*2%*0.5=39. The overall return rate is 39/800=4.875% (this example can be calculated according to the contents of the above functions, Table 1 and Table 7).

In one embodiment, the display screen shows that the overall return rate of the payment combination including the deposited cash and the campus market points is 70.5%. The overall return rate of the payment combination including the campus market points and the annual points is 107.25%. The overall return rate of the payment combination including the deposited cash and the credit card is 4.875%. In this example, since the overall return rate higher than the expected revenue weight is shown (for example, the user-defined expected revenue weight is 105%), the payment recommendation module 25 regards the configuration method including the campus market points and the annual points as the recommended payment combination.

Based on above, the payment type recommendation module 25 uses the dichotomy to determine a plurality of payment combinations according to the preference order. The current payment combinations include a payment proposal corresponding to a current preference order. The payment type recommendation module 25 calculates the remaining unallocated cost after selecting the payment proposal and determines whether the remaining unallocated cost is greater than zero. If the payment type recommendation module 25 determines that the remaining unallocated cost is greater than zero, the payment type recommendation module 25 selects another payment proposal corresponding to the current preference order. If the payment type recommendation module 25 determines that the remaining unallocated cost is equal to zero, the payment type recommendation module 25 calculates the overall return rate corresponding to each of the payment combinations and determines whether the overall return rate is greater than the expected revenue percentage. If the overall return rate is greater than the expected revenue percentage, the current payment combination is displayed. If the overall return rate is not greater than the expected revenue percentage, the payment type recommendation module 25 selects another payment proposal that is a second payment proposal corresponding to the current preference order.

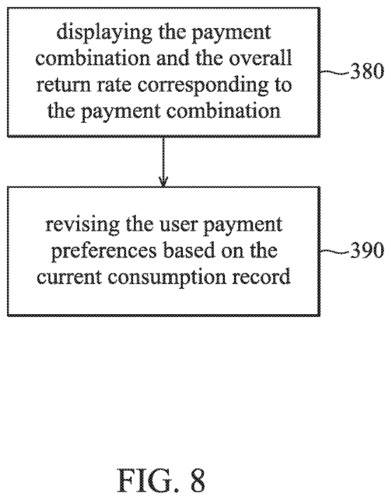

Please also refer to FIG. 8, FIG. 8 is a flowchart of revising method for revising the user payment preferences in accordance with one embodiment of the present disclosure. In one embodiment, after the step 380 of FIG. 3, the process proceeds to step 390. In step 390, the feedback calculation module 26 revises the user payment preferences based on the current consuming record.

In one embodiment, the feedback calculation module 26 continually corrects the original payment combination through the fine-tuning mechanism to correct the user payment preference according to the subsequent consumption record. The user payment preference may change with time or environment. The current payment type should be included. In this way, the user payment preference can be closer to the user's current situation. In one example, after the user A′ completes the current consumption as shown in Table IX below, the feedback calculation module 26 records a user payment for the current consumption.

TABLE IX

| payment | | current | | | | |
|---|---|---|---|---|---|---|
| type | user | consumption | 1^{st} day | 7^{th} day | 15^{th} day | 30^{th} day |
| annual | user A′ | 0 | 0.1 | 0.1 | 0.2 | 0.2 |
| points | | | | | | |
| deposited | user A′ | 0.5 | 0.4 | 0.8 | 0.7 | 0.6 |
| cash | | | | | | |
| campus | user A′ | 0.5 | 0.8 | 0.5 | 0.2 | 0.1 |
| market | | | | | | |
| points | | | | | | |
| credit | user A′ | 0 | 0 | 0 | 0 | 0 |
| card | | | | | | |

The feedback calculation module 26 recalculates the parameter PARₚₜ value, and the calculation formula is as follows:

$${PAR}_{p t} = \frac{{PAR}_{p t} \times n + {R}_{pw}}{n + 1}$$

The symbol R_{pw} is the payment ratio of the payment type of the group in the current consumption. The symbol n represents the total times of consumptions currently recorded, such as the four consumption time points above described. The symbol PARₚₜ represents the average consumption ratio of the payment type of company A group at a certain store. The feedback calculation module 26 recalculates the user payment preferences of the group based on the new PARₚₜ value. The user payment preference formula is as follows.

$${PR}_{p} = ( \frac{( {PAR}_{p t} + {AGR}_{p t} ) / 2}{{AR}_{p t}} )$$

Thus, the feedback calculation module 26 can continuously correct the prediction mechanism of the group based on a large number of consumption records and current consumption records. When the user is consuming, the mechanism can instantly calculate the payment combination of the appropriate payment type according to the consumption location and the group to which the consumer belongs.

By learning and adjusting the mechanism along with the user's consumption habits and time changes, the expectation recommendation mechanism can satisfy the consumer's expected expectation rules and seek the maximum expected revenue rate. This mechanism combines dynamic learning methods to calculate reasonable user payment preference values at different time points, and uses algorithms to dynamically plan and calculate various types of payment combinations. Finally, the mechanism calculates the expected revenue rate for each payment combination, and recommends the user to use the most appropriate payment combination according to the expected revenue rate.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

What is claimed is:

1. A payment type recommendation system, comprising:
a data storage device, configured to store an expected revenue weight corresponding to a payment type; and
a processor, configured to obtain payment data, generate a store group and a company group according to the payment type and a consumption location in the payment data, calculate a store payment average ratio according to the payment type corresponding to the store group, calculate a company average payment ratio according to the payment type corresponding to the company group, generate a user payment preference according to the company average payment ratio, define a preference order according to the amount of the user payment preference, calculate an overall return rate according to the preference order using a wholesale price, the expected revenue weight, the user payment preference, a payment combination, and a total cost, and display the payment combination and the overall return rate corresponding to the payment combination on a display screen.

2. The payment type recommendation system of claim 1, wherein the payment data comprises the payment type, global positioning system (GPS) data, consumer transaction data and consumer background information;
wherein the payment type comprises an annual point payment type, a deposited cash payment type, a campus market point payment type or a credit card payment type, the consumer transaction object data comprises store type, the global positioning system data comprises the consumption location, the consumer background information includes company, group name, gender profile and place of residence information.

3. The payment type recommendation system of claim 1, wherein the processor sums the proportion of the payment type corresponding to each of the time points in the store group to obtain an operation result, and the processor divides the operation result by the number of time points to obtain the store payment average ratio.

4. The payment type recommendation system of claim 1, wherein the processor sums the proportion of the payment type corresponding to each of the time points in the company group to obtain an operation result, and the processor divides the operation result by the number of time points to obtain the company payment average ratio.

5. The payment type recommendation system of claim 1, wherein the processor adds the store payment average ratio to the company payment average ratio for generating a temporary result, and divides the temporary result by two to obtain an operation result, and the processor divides the operation result by the store payment average ratio to get the user payment preference.

6. The payment type recommendation system of claim 1, wherein the processor uses the dichotomy to determine a plurality of payment combinations according to the preference order; wherein current payment combinations comprise a payment proposal corresponding to a current preference order, calculates a remaining unallocated cost after selecting the payment proposal, and determines whether the remaining unallocated cost is greater than zero;
if the remaining unallocated cost is greater than zero, the processor selects another payment proposal corresponding to the current preference order;
if the remaining unallocated cost is equal to zero, the processor calculates the overall return rate corresponding to each of the payment combinations, and determines whether the overall return rate is greater than an expected revenue percentage;
if the overall return rate is greater than the expected revenue percentage, the current payment combination is displayed;
if the overall return rate is not greater than the expected revenue percentage, the processor selects another payment proposal that is a second payment proposal corresponding to the current preference order.

7. The payment type recommendation system of claim 1, wherein the processor revises the user payment preferences based on current consumption record.

8. A payment type recommendation method, comprising:
obtaining payment data;
generating a store group and a company group according to payment type and consumption location in the payment data;
calculating the store payment average ratio according to the payment type corresponding to the store group;
calculating the company average payment ratio according to the payment type corresponding to the company group;
generating the user payment preference according to the company average payment ratio;
defining the preference order according to the amount of the user payment preference;
calculating the overall return rate according to the preference order using the wholesale price, the expected revenue weight, the user payment preference, a payment combination, and a total cost; and
displaying the payment combination and the overall return rate corresponding to the payment combination on a display screen.

9. The payment type recommendation method of claim 8, wherein the payment data comprises the payment type, global positioning system (GPS) data, consumer transaction data and consumer background information;
wherein the payment type comprises an annual point payment type, a deposited cash payment type, a campus market point payment type or a credit card payment type, the consumer transaction object data comprises store type, the global positioning system data comprises the consumption location, the consumer background information includes a company, a group name, a gender profile and place of residence information.

10. The payment type recommendation method of claim 8, further comprising:
summing the proportion of the payment type corresponding to each of the time points in the store group to obtain an operation result; and
dividing the operation result by the number of time points to obtain the store payment average ratio.
